(19) United States
(12) Patent Application Publication
(10) Pub. No.: US 2026/0113826 A1
(43) Pub. Date: Apr. 23, 2026

(54) SMART SWITCH AND SMART LIGHTING FIXTURE

(71) Applicant: SAVANT TECHNOLOGIES LLC, East Cleveland, OH (US)

(72) Inventors: Hongbin XU, Shanghai (CN); Zhiyong WANG, Shanghai (CN)

(73) Assignee: SAVANT TECHNOLOGIES LLC, East Cleveland, OH (US)

(21) Appl. No.: 19/284,124

(22) Filed: Jul. 29, 2025

(30) Foreign Application Priority Data
Aug. 14, 2024 (CN) 2024219786689

(51) Int. Cl. H05B 47/165; H05B 47/175; H05B 47/19

(52) U.S. Cl. CPC H05B 47/165; H05B 47/19; H05B 47/196

(57) ABSTRACT

Provided is a smart switch and a smart lighting fixture, the switch being electrically connected to a smart light load, and the switch includes a switch element electrically connecting a power source to the load, a switch operating element having an operating portion is manually operated to generate an operation signal and a control module having a first electrical connection terminal electrically connected to the source, a second electrical connection terminal electrically connected to the switch operating element to receive the operation signal, a third electrical connection terminal electrically connected to the switch element to control an operational state thereof, and a wireless communication unit for wireless communication with the load, the control module, in response to the operation signal having a predetermined signal pattern, controls the switch element to be closed, and converts subsequent operation signals from the switch operating element into wireless control signals for controlling the load.

### CROSS-REFERENCE TO RELATED APPLICATIONS

This application claims priority to Chinese Patent Application Serial Number 2024219786689, filed Aug. 14, 2024, which is herein incorporated by reference.

### TECHNICAL FIELD

The present application relates to a smart switch and a smart lighting fixture, and more particularly, to a smart switch that can keep a smart light load always powered on and ready to use in a simple manner, without relying on a specific application program, and a smart lighting fixture including same.

### BACKGROUND

A smart light usually has a built-in wireless chip for wireless communications with other devices. In order to maintain a ready-to-use state, the smart light needs to be continuously powered to stay ready for use, even when the light itself is not emitting any light. However, the smart light is usually installed in a circuit controlled by a traditional switch. In this case, operating the traditional switch will cut off the power supply, disconnecting the smart light from the power source. This is a major pain point for users of smart lights.

Existing Cync smart switches solve this problem by providing a configuration option of “smart light load”. When the Cync smart switch is set to the “smart light load” configuration mode, the Cync smart switch will keep a line voltage from the power source to the smart light always on, and only send a wireless command to the smart light when a switch button of the Cync smart switch is pressed. However, the “smart light load” configuration can only be achieved in the Cync application program. When a user uses the Cync smart switch with a third-party application program (for example, Matter application program), this function is not available because the third-party application program does not provide this configuration option.

In view of this, it is desirable to provide an improved smart switch for a smart light, which can always keep the smart light powered on and ready to use without relying on a specific application program, thereby being compatible with various application programs for controlling the smart light.

### SUMMARY OF THE INVENTION

The present application is proposed in view of the described problems. A main object of the present application is to provide a smart switch and a smart lighting fixture including same, so as to solve the technical problem in the prior art that it is difficult to always keep a smart light load powered on and ready to use without additionally configuring an application program.

In order to achieve the described object, according to one aspect of the present application, provided is a smart switch, electrically connected to a smart light load, the smart switch comprising: a switch element, configured to electrically connect a power source to the smart light load; a first switch operating element, comprising a first operating portion, the first operating portion can be manually operated to generate a first operation signal; and a programmable control module, comprising: a first electrical connection terminal, electrically connected to the power source; a second electrical connection terminal, electrically connected to the first switch operating element to receive the first operation signal from the first switch operating element; a third electrical connection terminal, electrically connected to the switch element to control an operational state of the switch element; and a wireless communication unit for wireless communication with the smart light load, wherein the programmable control module is configured to: in response to the received first operation signal from the first switch operating element having a predetermined first signal pattern, control the switch element to maintain a closed state, and convert subsequent first operation signals from the first switch operating element into wireless control signals for controlling the smart light load.

In this way, a user only needs to perform a particular first operation on the first switch operating element to generate the first operation signal having the first signal pattern, such that the smart light load always remains powered on and ready to use for smart control by a predetermined application program. This prevents the smart light load from being disconnected from the power source caused by the user's manual operation on the first switch operating element. Moreover, the user may continue to manually operate the first switch operating element to control the light-emitting state of the smart light load. Thus, without additionally configuring an application program, the smart light load can be always kept powered on and ready to use for manual operation control of the first switch operating element or smart control of an external application program. Therefore, without additionally configuring an application program, the smart light load is always kept powered on and ready to use, without being disconnected from the power source due to the manual operation of the user.

Further, according to an embodiment of the present application, the first switch operating element comprises a first conductive terminal and a second conductive terminal, wherein the first conductive terminal is connected to the ground, and the second conductive terminal is connected to the second electrical connection terminal of the programmable control module.

In this way, by manual operation on the first switch operating element, the second electrical connection terminal of the programmable control module may be at a ground potential or non-ground potential, such that the first operation signal composed of different levels can be generated at the second electrical connection terminal of the programmable control module.

Further, according to an embodiment of the present application, the switch element comprises an on-off switch, and the first switch operating element is a switch button.

In this way, in cases where the switch element comprises or is an on-off switch and the first switch operating element is a switch button, without additionally configuring an application program, the smart light load can be always kept powered on and ready to use.

Further, according to an embodiment of the present application, the smart switch further comprises a resistor, the resistor being arranged between the power source and the second electrical connection terminal of the programmable control module.

In this way, in cases where the switch element comprises or is an on-off switch, a high-level or low-level signal can be generated by the manual operation on the first switch operating element.

Further, according to an embodiment of the present application, the switch element comprises a dimmer, and the first switch operating element is a potentiometer.

In this way, in cases where the switch element comprises or is a dimmer and the first switch operating element is a potentiometer, without additionally configuring an application program, the smart light load can be always kept powered on and ready to use.

Further, according to an embodiment of the present application, the first conductive terminal is a first fixed terminal pin of the first switch operating element, and the second conductive terminal is a sliding terminal pin of the first switch operating element; and the first switch operating element further comprises a second fixed terminal pin, and the second fixed terminal pin is connected to the power source.

In this way, in cases where the switch element comprises or is a dimmer, voltage signals of different levels can be generated by the manual operation on the first switch operating element.

Further, according to an embodiment of the present application, the smart switch further comprises a second switch operating element, wherein the second switch operating element is connected between the second conductive terminal of the first switch operating element and the second electrical connection terminal of the programmable control module; the second switch operating element comprises a second operating portion, the second operating portion can be manually operated to generate a second operation signal, wherein the programmable control module is configured to: in response to a combination of the received first operation signal from the first switch operating element and the second operation signal from the second switch operating element having the predetermined first signal pattern, control the switch element to maintain the closed state.

In this way, by using the combination of the first switch operating element and the second switch operating element, it is easy to set a first operation corresponding to the predetermined first signal pattern; and it is easy to avoid entering or exiting a smart load control mode due to user misoperations in the case of a single switch operating element.

Further, according to an embodiment of the present application, the second switch operating element comprises an airgap switch.

In this way, the smart switch can enter or exit the smart load control mode by manual operation on the combination of the airgap switch and the on-off switch or dimmer.

Further, according to an embodiment of the present application, the programmable control module is a microcontroller unit.

In this way, various functions of the programmable control module can be implemented by using the microcontroller unit.

According to another aspect of the present application, provided is a smart lighting fixture, the smart lighting fixture comprising: the smart switch as described above; and a smart light load, electrically connected to a switch element of the smart switch and configured to wirelessly communicate with a programmable control module of the smart switch.

In this way, without additionally configuring an application program, the smart light load is always kept powered on and ready to use, without being disconnected from the power source due to the manual operation of the user.

Further, according to an embodiment of the present application, the smart light load comprises a communication unit, a driving unit and a light-emitting unit, wherein the driving unit is electrically connected between the light-emitting unit and the switch element, and the driving unit is also electrically connected to the communication unit, and the communication unit is configured to wirelessly communicate with a wireless communication unit of the programmable control module.

Further, according to an embodiment of the present application, a first switch operating element of the smart switch is arranged on the wall of a room, and the smart light load is arranged on the ceiling of the room.

Embodiments of the present application provide a smart switch, which is electrically connected to a smart light load, the smart switch comprising: a switch element, configured to electrically connect a power source to the smart light load; a first switch operating element, comprising a first operating portion, the first operating portion can be manually operated to generate a first operation signal; and a programmable control module, comprising: a first electrical connection terminal, electrically connected to the power source; a second electrical connection terminal, electrically connected to the first switch operating element to receive the first operation signal from the first switch operating element; a third electrical connection terminal, electrically connected to the switch element to control an operational state of the switch element; and a wireless communication unit for wireless communication with the smart light load, wherein the programmable control module is configured to: in response to the received first operation signal from the first switch operating element having a predetermined first signal pattern, control the switch element to maintain a closed state, and convert subsequent first operation signals from the first switch operating element into wireless control signals for controlling the smart light load, so as to at least solve the technical problem in the prior art that it is difficult to always keep a smart light load powered on and ready to use without additionally configuring an application program, thereby achieving the technical effect that without additionally configuring an application program, the smart light load is always kept powered on and ready to use, without being disconnected from the power source due to the manual operation of the user.

### BRIEF DESCRIPTION OF THE DRAWINGS

The drawings accompanying the description and constituting a part of the present application are used for providing further understanding of the present application, and the illustrative embodiments of the present application and illustrations thereof are used to explain the present application, rather than constitute inappropriate limitation on the present application. In the drawings:

FIG. 1 is a schematic diagram of circuit connection of a smart switch and a smart light load according to embodiments of the present application;

FIG. 2 is a schematic diagram of circuit connection of a smart switch and a smart light load according to an exemplary embodiment of the present application;

FIG. 3 is a schematic diagram of circuit connection of a smart switch and a smart light load according to another exemplary embodiment of the present application;

FIG. 4 is a schematic diagram of circuit connection of a smart switch and a smart light load according to still another exemplary embodiment of the present application; and

FIG. 5 is an exemplary diagram of a first switch operating element and a second switch operating element as shown in FIG. 4.

### DETAILED DESCRIPTION

It is to be noted that embodiments in the present application and features in the embodiments may be combined with one another without conflicts. Hereinafter, the present application is described in detail with reference to the accompanying drawings and in conjunction with the embodiments.

It is to be noted that unless otherwise indicated, all technical and scientific terms used in the present application have the same meanings as those commonly understood by a person of ordinary skill in the art to which the present application belongs.

In the present application, unless specified to the contrary, directional terms such as “upper, lower, top and bottom” are generally used regarding the directions shown in the figures, or for the components themselves in vertical, perpendicular or gravity directions; likewise, for ease of understanding and description, “internal, external” refer to internal and external relative to the outline of each component itself, but the described directional terms are not used to limit the present application.

An object of the present application is to provide an improved smart switch and a smart lighting fixture including same, in which the smart switch can always keep a smart light load powered on and ready to use for wireless control without relying on a specific application program, thereby being compatible with all application programs for controlling the smart light.

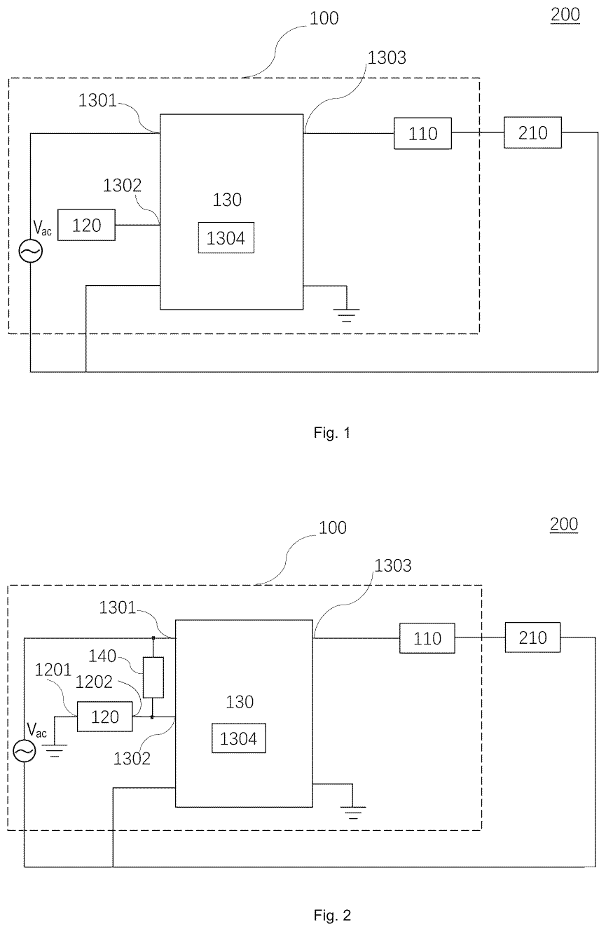

FIG. 1 is a schematic diagram of circuit connection of a smart switch and a smart light load according to embodiments of the present application. As shown in FIG. 1, a smart switch 100 according to the present application is electrically connected to a smart light load 210, and the smart switch 100 comprises: a switch element 110, configured to electrically connect a power source to the smart light load 210; a first switch operating element 120, comprising a first operating portion which can be manually operated to generate a first operation signal; and a programmable control module 130, comprising: a first electrical connection terminal 1301, electrically connected to the power source; a second electrical connection terminal 1302, electrically connected to the first switch operating element 120 to receive the first operation signal from the first switch operating element 120; a third electrical connection terminal 1303, electrically connected to the switch element 110 to control an operational state of the switch element 110; and a wireless communication unit 1304 for wireless communication with the smart light load 210, wherein the programmable control module 130 is configured to: in response to the received first operation signal from the first switch operating element 120 having a predetermined first signal pattern, control the switch element 110 to maintain a closed state, and convert subsequent first operation signals from the first switch operating element 120 into wireless control signals for controlling the smart light load 210.

In the present application, the functions of the programmable control module 130 are realized by programming the programmable control module 130. Specific programming methods are well known to a person skilled in the art. In addition, the functions realized by the programmable control module 130 are also the prior art well known to a person skilled in the art.

In the present application, the first switch operating element 120 generates the first operation signal in response to a user's manual operation on the operating portion. The first operation signal is inputted to the programmable control module 130 to control the operational state of the switch element 110 or to control a driving voltage or driving current of a driving element of the smart light load 210.

With the arrangement above, when the first operation signal from the first switch operating element 120 received by the programmable control module 130 does not have the predetermined first signal pattern, the smart switch 100 may be in a normal control mode. In this mode, the programmable control module 130 can directly control the operational state of the switch element 110 according to the first operation signal of the first switch operating element 120, so as to control the operational state of the light load according to the user's manual operation, like a traditional lighting fixture. When the first operation signal from the first switch operating element 120 received by the programmable control module 130 has the predetermined first signal pattern, in response to determining that the first operation signal has the predetermined first signal pattern, the programmable control module 130 may control the smart switch 100 to enter a smart load control mode. In the smart load control mode, the switch element 110 is always maintained in the closed state. At this time, a power source voltage Vac from the power source (e.g. an alternating-current power source) is always supplied to the smart light load 210, without being affected by the manual operation of the user on the first switch operating element 120. In addition, at this time, the first operation signal generated by the user's manual operation on the first switch operating element 120 will be converted by the programmable control module 130 into a wireless control signal for controlling the smart light load 210. The programmable control module 130 may send the wireless control signal to a driving element of the smart light load 210 by using a communication module, such that the driving element controls a driving voltage or a driving current outputted by the driving element according to the wireless control signal, thereby controlling a light-emitting state of a light-emitting element of the smart light load 210.

Further, regardless of the normal control mode or the smart load control mode, the light-emitting state of the smart light load 210 may also be controlled by an external application program. The application program may reside on a mobile device and be programmed to wirelessly communicate with the communication unit of the smart light load 210, thereby controlling the light-emitting state of a light-emitting unit of the smart light load 210 in a wireless manner.

Thus, the user only needs to perform a particular first operation on the first switch operating element 120 to generate the first operation signal having the first signal pattern, such that the smart light load 210 always remains powered on and ready to use for smart control by a predetermined application program. This prevents the smart light load 210 from being disconnected from the power source caused by the user's manual operation on the first switch operating element, which would result in the inability to achieve smart control on the smart light load. Moreover, the user may continue to manually operate the first switch operating element 120 to control the light-emitting state of the smart light load 210. Thus, without additionally configuring an application program, the smart light load 210 can be always kept powered on and ready to use for manual operation control of the first switch operating element or smart control of an external application program.

In the present application, the first switch operating element 120 comprises a first conductive terminal 1201 and a second conductive terminal 1202, wherein the first conductive terminal 1201 is connected to the ground, and the second conductive terminal 1202 is connected to the second electrical connection terminal 1302 of the programmable control module 130, as shown in FIGS. 2-4. Thus, by manual operation on the first switch operating element 120, the second electrical connection terminal 1302 of the programmable control module 130 may be at a ground potential or non-ground potential. Thus, the potential of the second electrical connection terminal 1302 can be changed according to different manual operations, such that the first operation signal composed of different levels can be generated at the second electrical connection terminal 1302.

In the present application, the switch element 110 may comprise an on-off switch or a dimmer. Accordingly, the first switch operating element 120 may comprise a switch button corresponding to the on-off switch or a potentiometer (e.g. a potentiometer with a rotary button or a slide button) corresponding to the dimmer. In the present application, the on-off switch is an electronic switch, which includes but is not limited to, a switch device of which the closing or opening can be controlled by the programmable control module 130, e.g. a relay, a transistor, an MOSFET, an optical coupler, etc. The first switch operating element 120 is a mechanical switch which includes but is not limited to a switch device which can be manually operated to achieve closing or opening, e.g. a push button switch, a toggle switch, a slide switch, a selector switch, a knife switch, an airgap switch, a manual circuit breaker, etc.

In an exemplary embodiment of the present application, the switch element 110 comprises an on-off switch, and the first switch operating element 120 is a switch button (i.e. a push button switch). In this case, the button portion of the switch button may be used as the first operating portion. In another exemplary embodiment of the present application, the switch element 110 comprises a dimmer, and the first switch operating element 120 is a potentiometer. In this case, the rotary button or slide button of the potentiometer may be used as the first operating portion.

In the present application, the first signal pattern may be a signal pattern represented by a specific sequence of high and low levels. A first operation resulting in the first operation signal having the first signal pattern may be preset.

In an exemplary embodiment, the switch element 110 comprises an on-off switch, and the first operation may be pressing a button portion of a switch button corresponding thereto for a predetermined time and then releasing same, or releasing the button portion for a predetermined time and then pressing same. This may correspond to turning the switch button off for a predetermined time and then turning same on, or turning the switch button on for a predetermined time and then turning same off, thereby generating the first operation signal having a low level of a predetermined length or a high level of a predetermined length. Alternatively, the first operation may be sequentially pressing, releasing, re-pressing and re-releasing the button portion of the corresponding switch button for a predetermined number of times within a predetermined period of time, so as to generate the first operation signal as a cyclic sequence of high and low levels with a predetermined number of cycles; and at this time, the first signal pattern may be the cyclic sequence of high and low levels with the predetermined number of cycles.

In another exemplary embodiment, the switch element 110 comprises a dimmer, and the first operation may be adjusting the first operating portion (e.g. a rotary button) of the corresponding potentiometer to the lowest gear (which may correspond to 180-degree phase cut) for a predetermined time, and then adjusting to the highest gear (which may correspond to 0-degree phase cut), or adjusting to the highest gear for a predetermined time and then adjusting to the lowest gear. This may also generate the first operation signal having a low voltage of a predetermined length or a high voltage of a predetermined length. Alternatively, the first operation may also be sequentially adjusting the first operating portion of the potentiometer to the highest gear, the lowest gear, the highest gear and the lowest gear for a predetermined number of times within a predetermined period of time, so as to generate the first operation signal as a cyclic sequence of high and low levels with a predetermined number of cycles; and at this time, the first signal pattern may be the cyclic sequence of high and low levels with the predetermined number of cycles. Alternatively, the first operation may also comprise any number of times of adjustments of intermediate gears, and at this time, the first signal pattern may be a voltage sequence consisting of voltage signals of different levels in a predetermined arrangement.

Further, in the present application, in cases where the smart switch 100 is in the smart load control mode, the programmable control module 130 may also control the smart switch 100 to exit the smart load control mode and return to the normal control mode in response to the received first operation signal from the first switch operating element 120 having a predetermined second signal pattern. The second signal pattern may be a signal pattern represented by a specific sequence of high and low levels, which is similar to the first signal pattern, and therefore will not be repeated herein. A second operation resulting in the first operation signal having the second signal pattern may be preset. In addition, the second signal pattern may be different from the first signal pattern.

Additionally, in the normal control mode, the programmable control module 130 does not control the smart light load 210 in a wireless manner.

In order to achieve a high-level or low-level signal generated by the manual operation on the first switch operating element 120, in an exemplary embodiment, when the switch element 110 comprises an on-off switch and the first switch operating element 120 is a switch button (e.g. a normally-open or normally-closed push button switch), a resistor 140 may be further provided in the smart switch 100. FIG. 2 shows a schematic diagram of an exemplary circuit connection of the smart switch 100 and the smart light load 210 in cases where the switch element 110 comprises an on-off switch.

As shown in FIG. 2, the first conductive terminal 1201 of the first switch operating element 120 is connected to the ground, and the second conductive terminal 1202 of the first switch operating element 120 is connected to the second electrical connection terminal 1302 of the programmable control module 130. In addition, the smart switch 100 further comprises a resistor 140, the resistor 140 being connected between the power source and the second electrical connection terminal 1302.

At this time, the resistor 140 may operate as a pull-up resistor or a pull-down resistor. When the switch button is not pressed (i.e. released), the second electrical connection terminal 1302 may be at a fixed high level (or low level); and when the switch button is pressed, the second electrical connection terminal 1302 may be at a fixed low level (or high level). Accordingly, the programmable control module 130 may acquire the first operation signal from the first switch operating element 120 by reading the level state of the second electrical connection terminal 1302.

In an exemplary embodiment of the present application, the programmable control module 130 may be a microcontroller unit (MCU). At this time, the second electrical connection terminal 1302 may be a digital input pin of the programmable control module 130.

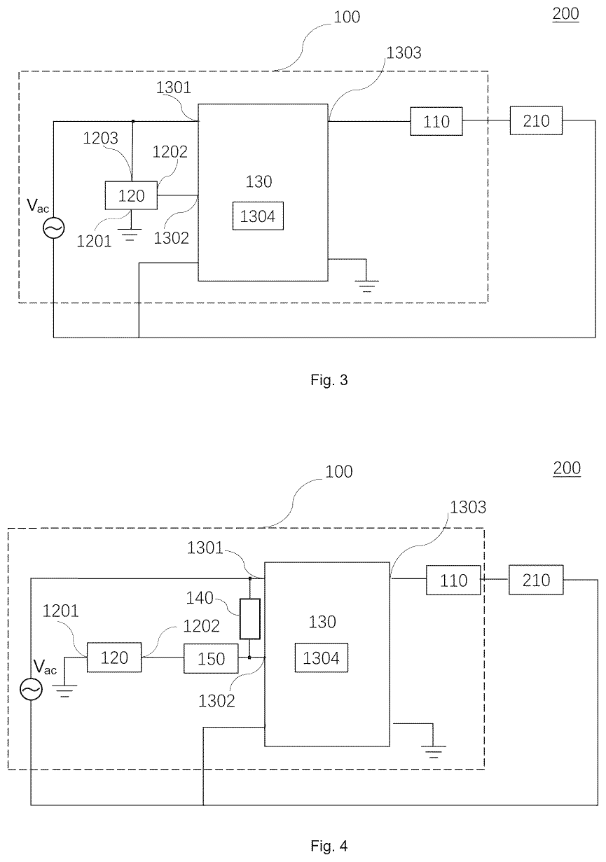

In order to generate voltage signals of different levels by manual operation on the first switch operating element 120, in another exemplary embodiment, when the switch element 110 comprises a dimmer and the first switch operating element 120 is a potentiometer, a particular connection between the potentiometer and the programmable control module 130 can be provided in the smart switch 100. FIG. 3 shows a schematic diagram of an exemplary circuit connection of the smart switch 100 and the smart light load 210 in cases where the switch element 110 comprises a dimmer.

As shown in FIG. 3, the first switch operating element 120 as a potentiometer comprises a first fixed terminal pin and a sliding terminal pin. The first conductive terminal 1201 is the first fixed terminal pin connected to the ground, and the second conductive terminal 1202 is the sliding terminal pin connected to the second electrical connection terminal 1302 of the programmable control module 130. In addition, the first switch operating element 120 further comprises a second fixed terminal pin 1203, and the second fixed terminal pin 1203 is connected to the power source.

In this case, by adjusting the first operating portion of the first switch operating element 120, the resistance value between the second electrical connection terminal 1302 of the programmable control module 130 and an output terminal of the power source can be varied, thereby altering the voltage level of the second electrical connection terminal 1302. Accordingly, the programmable control module 130 may acquire the first operation signal from the first switch operating element 120 by reading the level state of the second electrical connection terminal 1302.

When the programmable control module 130 is a microcontroller unit, the second electrical connection terminal 1302 may be an analog input pin of the programmable control module 130.

Further, in the embodiments of the present application, in order to generate the first operation signal having the predetermined first signal pattern, in addition to the first switch operating element 120, the smart switch 100 may further comprise one or more second switch operating elements 150. FIG. 4 is a schematic diagram of circuit connection of the smart switch comprising an additional second switch operating element and the smart light load according to still another exemplary embodiment of the present application. As an example, FIG. 4 shows a situation in which the smart switch 100 shown in FIG. 2 comprises an additional second switch operating element 150.

As shown in FIG. 4, the second switch operating element 150 is connected between the second conductive terminal 1202 of the first switch operating element 120 and the second electrical connection terminal 1302 of the programmable control module 130. Alternatively, the second switch operating element 150 may be connected between the first conductive terminal 1201 of the first switch operating element 120 and ground.

Further, the second switch operating element 150 may be connected between a line connecting the resistor 140 to the second electrical connection terminal 1302, and the second conductive terminal 1202 of the first switch operating element 120. The second switch operating element 150 may comprise a second operating portion. The second operating portion can be manually operated to generate a second operation signal. At this time, the programmable control module 130 may in response to a combination of the received first operation signal from the first switch operating element 120 and the second operation signal from the second switch operating element 150 having the predetermined first signal pattern, control the switch element 110 to maintain the closed state. Thereafter, the programmable control module 130 may convert subsequent first operation signals from the first switch operating element 120 into wireless control signals for controlling the smart light load 210, instead of directly controlling the operational state of the switch element 110 in accordance with the subsequent first operation signals. The combination of the operation signals having the predetermined first signal pattern may be generated by the user performing the first operation on a whole of the first switch operating element 120 and the second switch operating element 150. In the present application, the second switch operating element 150 may be a mechanical switch, such as a push button switch, an airgap switch, or the like. The second switch operating element 150 and the first switch operating element 120 may be the same type of mechanical switch or different types of mechanical switches.

In FIG. 4, when either of the first switch operating element 120 and the second switch operating element 150 is not pressed, the second electrical connection terminal 1302 of the programmable control module 130 may be at a fixed high level (or low level); and when both of the first switch operating element 120 and the second switch operating element 150 are pressed, the second electrical connection terminal 1302 may be at a fixed low level (or high level). Accordingly, the programmable control module 130 may acquire the combination of the first operation signal from the first switch operating element 120 and the second operation signal from the second switch operating element 150 by reading the level state of the second electrical connection terminal 1302. Then, in the normal control mode, the programmable control module 130 may control the smart switch 100 to enter the smart load control mode in response to the combination of the operation signals having the predetermined first signal pattern. In the smart load control mode, the programmable control module 130 may control the smart switch 100 to exit the smart load control mode in response to the combination of the operation signals having the predetermined second signal pattern.

It should be noted that, although FIG. 4 shows a situation in which the smart switch 100 shown in FIG. 2 comprises an additional second switch operating element 150, in a situation in which the switch element 110 comprises a dimmer (i.e. in the situation shown in FIG. 3), the smart switch 100 may also comprise an additional second switch operating element 150. In this case, the second switch operating element 150 may be connected between the sliding terminal pin of the first switch operating element 120 and the second electrical connection terminal 1302 of the programmable control module 130, or connected between the first fixed terminal pin of the first switch operating element 120 and the ground.

By providing the additional second switch operating element 150, and enabling the programmable control module 130 to control the smart switch 100 to enter the smart load control mode in response to the combination of the operation signals from the first switch operating element 120 and the second switch element 150 having the predetermined first signal pattern, it can prevent entering or exiting the smart load control mode due to user misoperations in the case of a single switch operating element.

Further, the second switch operating element 150 may be arranged within a predetermined distance from the first switch operating element 120, such that it is easy for the user to operate both switch operating elements simultaneously.

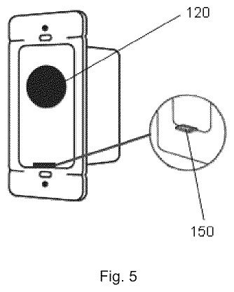

FIG. 5 is an exemplary diagram of the first switch operating element and the second switch operating element as shown in FIG. 4. As shown in FIG. 5, the first switch operating element 120 is a push button switch, the push button portion thereof is represented by a colored circle; and the second switch operating element 150 is an airgap switch, which can be manually pulled out (representing open) or pushed in (representing closed). FIG. 5 shows the airgap switch in a pulled-out state. The second switch operating element 150 and the first switch operating element 120 are arranged adjacent to each other on the same switch panel to facilitate manual operation by a person. In the exemplary arrangement of the first switch operating element and the second switch operating element shown in FIG. 5, the first operation may be for example: pulling out the airgap switch first, and then pressing and holding the first switch operating element 120 for several seconds (for example 3, 4, 5 seconds, etc.) while pushing in the second switch operating element 150. It should be noted that FIG. 5 is only an exemplary illustration, and the first switch operating element 120 and the second switch operating element 150 may also use other switch types, or other arrangements, as long as the predetermined first operation signal can be generated at the second electrical connection terminal 1302 of the programmable control module 130 by a manual operation.

The present application further provides a smart lighting fixture 200. The smart lighting fixture 200 may comprise the described smart switch 100 and the smart light load 210. As shown in FIGS. 1-4, the smart light load 210 may be electrically connected to a switch element 110 of the smart switch 100, and configured to wirelessly communicate with a programmable control module 130 of the smart switch 100.

In particular, the smart light load 210 may comprise a communication unit, a driving unit, and a light-emitting unit (not shown). The driving unit can be electrically connected between the light-emitting unit and the switch element 110 of the smart switch 100, and the driving unit can also be electrically connected to the communication unit. The communication unit may wirelessly communicate with a wireless communication unit 1304 of the programmable control module 130. Thus, when the smart switch 100 enters a smart load control mode, the driving unit of the smart light load 210 can receive a wireless control signal from the programmable control module 130 via the communication unit, and control a driving voltage or a driving current of the driving unit according to the wireless control signal, so as to control the light-emitting state of the light-emitting unit.

In an exemplary embodiment of the present invention, a first switch operating element 120 of the smart switch 100 may be arranged on the wall of a room, and the smart light load 210 may be arranged on the ceiling of the room. Thus, the smart light load 210 of the room can be always kept powered on and ready to use for wireless control, without being affected by the user's operation on the switch on the wall.

The smart lighting fixture 200 according to the present application comprises the configurations and functions of the smart switch 100 and the smart light load 210 as described above with reference to the accompanying drawings, and thus will not be elaborated herein.

It should be noted that in the present application, control functions implemented by the programmable control module 130 are known to a person skilled in the art.

It should be noted that the terms used herein are for the purpose of describing specific embodiments only and are not intended to limit exemplary embodiments according to the present application. As used herein, the singular form is intended to comprise the plural form as well, unless the context clearly indicates otherwise, and further it should be understood that the terms “comprises” and/or “comprising” when used in the present description, specify the presence of features, steps, operations, devices, assemblies and/or combinations thereof.

It should be noted that the terms “first”, “second” etc., in the description, claims, and accompanying drawings of the present application are used to distinguish similar objects, and are not necessarily used to describe a specific sequence or order. It should be understood that the data so used may be interchanged where appropriate so that the embodiments of the present application described herein can be implemented in sequences other than those illustrated or described herein.

The content above merely relates to preferred embodiments of the present application and is not intended to limit the present application. For a person skilled in the art, the present application may have various modifications and variations. Any modifications, equivalent replacements, improvements, etc. made within the spirit and principle of the present application shall all belong to the scope of protection of the present application.

1. A smart switch, electrically connected to a smart light load, the smart switch comprising:
a switch element, configured to electrically connect a power source to the smart light load;
a first switch operating element, comprising a first operating portion, the first operating portion can be manually operated to generate a first operation signal; and
a programmable control module, comprising:
a first electrical connection terminal, electrically connected to the power source;
a second electrical connection terminal, electrically connected to the first switch operating element to receive the first operation signal from the first switch operating element;
a third electrical connection terminal, electrically connected to the switch element to control an operational state of the switch element; and
a wireless communication unit for wireless communication with the smart light load,
wherein the programmable control module is configured to: in response to the received first operation signal from the first switch operating element having a predetermined first signal pattern, control the switch element to maintain a closed state, and convert subsequent first operation signals from the first switch operating element into wireless control signals for controlling the smart light load.

2. The smart switch according to claim 1, wherein the first switch operating element comprises a first conductive terminal and a second conductive terminal, wherein the first conductive terminal is connected to the ground, and the second conductive terminal is connected to the second electrical connection terminal of the programmable control module.

3. The smart switch according to claim 2, wherein the switch element comprises an on-off switch, and the first switch operating element is a switch button.

4. The smart switch according to claim 3, wherein the smart switch further comprises a resistor, the resistor being arranged between the power source and the second electrical connection terminal of the programmable control module.

5. The smart switch according to claim 2, wherein the switch element comprises a dimmer, and the first switch operating element is a potentiometer.

6. The smart switch according to claim 5, wherein the first conductive terminal is a first fixed terminal pin of the first switch operating element, and the second conductive terminal is a sliding terminal pin of the first switch operating element; and
the first switch operating element further comprises a second fixed terminal pin, and the second fixed terminal pin is connected to the power source.

7. The smart switch according to claim 2, wherein the smart switch further comprises a second switch operating element,
wherein the second switch operating element is connected between the second conductive terminal of the first switch operating element and the second electrical connection terminal of the programmable control module;
the second switch operating element comprises a second operating portion, the second operating portion can be manually operated to generate a second operation signal,
wherein the programmable control module is configured to: in response to a combination of the received first operation signal from the first switch operating element and the second operation signal from the second switch operating element having the predetermined first signal pattern, control the switch element to maintain the closed state.

8. The smart switch according to claim 7, wherein the second switch operating element comprises an airgap switch.

9. The smart switch according to claim 1, wherein the programmable control module is a microcontroller unit.

10. A smart lighting fixture, the smart lighting fixture comprising:
the smart switch according to claim 1; and
a smart light load, electrically connected to a switch element of the smart switch and configured to wirelessly communicate with a programmable control module of the smart switch.

11. The smart lighting fixture according to claim 10, wherein the smart light load comprises a communication unit, a driving unit and a light-emitting unit,
wherein the driving unit is electrically connected between the light-emitting unit and the switch element, and the driving unit is also electrically connected to the communication unit, and
the communication unit is configured to wirelessly communicate with a wireless communication unit of the programmable control module.

12. The smart lighting fixture according to claim 10, wherein a first switch operating element of the smart switch is arranged on the wall of a room, and the smart light load is arranged on the ceiling of the room.
